(19) United States
(12) Patent Application Publication
(10) Pub. No.: US 2020/0053567 A1
(43) Pub. Date: Feb. 13, 2020

(54) SECURITY ARCHITECTURE FOR MACHINE TYPE COMMUNICATIONS

(71) Applicant: NOKIA SOLUTIONS AND NETWORKS OY, Espoo (FI)

(72) Inventors: Mehrnoosh MONSHIZADEH, Espoo (FI); Vikramajeet KHATRI, Espoo (FI); Kari Jukka Tapio TIIRIKAINEN, Vantaa (FI)

(21) Appl. No.: 16/476,406

(22) PCT Filed: Jan. 11, 2017
(86) PCT No.: PCT/EP2017/050473

§ 371 Date: Jul. 8, 2019

(51) Int. Cl. H04W 12/12; H04W 4/70; H04W 24/08; H04L 29/06; H04W 12/06

(52) U.S. Cl. CPC H04W 12/1204; H04W 4/70; H04W 12/06; H04W 12/1208; H04L 63/1425; H04W 24/08

(57) ABSTRACT

Various communication systems may benefit from increased security. For example, communication systems that include machine type communications may benefit from improved security and fault detection. A method, in certain embodiments, may include receiving data at an internet of things module in a mobile network from a robot controller. The data includes sensor information from a plurality of machine type communication devices. The method may also include detecting an attack on the mobile network based on the sensor information. In addition, the method may include determining a preventive action to prevent the attack. Further, the method may include sending an indication of the attack to at least one of the robot controller, another robot controller, or another internet of things module. The indication includes the preventive action.

### BACKGROUND

### Field

Various communication systems may benefit from increased security. For example, communication systems that include machine type communications devices may benefit from improved security and fault detection.

### Description of the Related Art

Cloud computing, Internet of Things (IoT), and machine type communication (MTC) devices have been a developing area of technology that have been used in combination to help operate cloud robotics. Cloud robotics utilizes big data techniques, such as those provided for in IoT, and the computing power found in cloud computing to facilitate connectivity of the MTC devices to mobile networks and other wireless technologies. The mobile network, for example, may be a 3rd Generation Partnership Project (3GPP) Long Term Evolution (LTE) network. MTC devices, which utilize both cloud computing and big data techniques, can be referred to as mobile cloud robots (MCR).

The evolution of MCR devices has exacerbated security concerns related to the massive widespread use of such devices. Certain types of MCR devices, such as robot or flying robot, known as drones, are being used in various environments, and in particular in service industries. Drones, for example, are used for postal delivery, parcel delivery, vaccine delivery, remote surveillance, and inspection of terrain for radio network planning A secure platform for managing and guiding such MCR devices, and their respective environments, can be used to prevent potential harms to the MCR devices themselves, as well as the mobile or wireless networks with which the MCR devices communicate.

### SUMMARY

A method, in certain embodiments, may include receiving data at a robot controller from a plurality of machine type communication devices. The data comprises sensor information from the plurality of machine type communication devices. The method may also include forwarding the received data to an internet of things module in a mobile network. The sensor information is analyzed to detect an attack on the mobile network. In addition, the method may include receiving at the robot controller an indication of the attack from the internet of things module in the mobile network. Further, the method may include performing the prevention action to prevent the attack.

According to certain embodiments, an apparatus may include at least one memory including computer program code, and at least one processor. The at least one memory and the computer program code may be configured, with the at least one processor, to cause the apparatus at least to receive data at a robot controller from a plurality of machine type communication devices. The data includes sensor information from the plurality of machine type communication devices. The at least one memory and the computer program code may also be configured, with the at least one processor, at least to forward the received data to an internet of things module in a mobile network. The sensor information is analyzed to detect an attack on the mobile network. In addition, the at least one memory and the computer program code may also be configured, with the at least one processor, at least to receive at the robot controller an indication of the attack from the internet of things module in the mobile network. The indication includes a prevention action. Further, the at least one memory and the computer program code may also be configured, with the at least one processor, at least to perform the prevention action to prevent the attack.

An apparatus, in certain embodiments, may include means for receiving data at a robot controller from a plurality of machine type communication devices. The data includes sensor information from the plurality of machine type communication devices. The apparatus may also include means for forwarding the received data to an internet of things module in a mobile network. The sensor information is analyzed to detect an attack on the mobile network. In addition, the apparatus may include means for receiving at the robot controller an indication of the attack from the internet of things module in the mobile network. The indication includes a prevention action. Further, the apparatus may include means for performing the prevention action to prevent the attack.

According to certain embodiments, a non-transitory computer-readable medium encoding instructions that, when executed in hardware, perform a process. The process may include receiving data at a robot controller from a plurality of machine type communication devices. The data includes sensor information from the plurality of machine type communication devices. The process may also include forwarding the received data to an internet of things module in a mobile network. The sensor information is analyzed to detect an attack on the mobile network. In addition, the process may include receiving at the robot controller an indication of the attack from the internet of things module in the mobile network. The indication includes a prevention action. Further, the processor may include performing the prevention action to prevent the attack

According to certain embodiments, a computer program product encoding instructions receiving data at a robot controller from a plurality of machine type communication devices. The data includes sensor information from the plurality of machine type communication devices. The method may also include forwarding the received data to an internet of things module in a mobile network. The sensor information is analyzed to detect an attack on the mobile network. In addition, the method includes receiving at the robot controller an indication of the attack from the internet of things module in the mobile network. The indication includes a prevention action. Further, the method includes performing the prevention action to prevent the attack.

A method, in certain embodiments, may include receiving data at an internet of things module in a mobile network from a robot controller. The data includes sensor information from a plurality of machine type communication devices. The method may also include detecting an attack on the mobile network based on the sensor information. In addition, the method may include determining a preventive action to prevent the attack. Further, the method may include sending an indication of the attack to at least one of the robot controller, another robot controller, or another internet of things module. The indication includes the preventive action.

According to certain embodiments, an apparatus may include at least one memory including computer program code, and at least one processor. The at least one memory and the computer program code may be configured, with the at least one processor, to cause the apparatus at least to receive data at an internet of things module in a mobile network from a robot controller. The data includes sensor information from a plurality of machine type communication devices. The at least one memory and the computer program code may also be configured, with the at least one processor, at least to detect an attack on the mobile network based on the sensor information. In addition, the at least one memory and the computer program code may be configured, with the at least one processor, at least to determine a preventive action to prevent the attack. Further, the at least one memory and the computer program code may be configured, with the at least one processor, at least to sending an indication of the attack to at least one of the robot controller, another robot controller, or another internet of things module. The indication includes the preventive action.

An apparatus, in certain embodiments, may include means for receiving data at an internet of things module in a mobile network from a robot controller. The data includes sensor information from a plurality of machine type communication devices. The apparatus may also include means for detecting an attack on the mobile network based on the sensor information. In addition, the apparatus may include means for determining a preventive action to prevent the attack. Further, the apparatus may include sending an indication of the attack to at least one of the robot controller, another robot controller, or another internet of things module. The indication includes the preventive action.

According to certain embodiments, a non-transitory computer-readable medium encoding instructions that, when executed in hardware, perform a process. The process may include receiving data at an internet of things module in a mobile network from a robot controller. The data includes sensor information from a plurality of machine type communication devices. The process may also include detecting an attack on the mobile network based on the sensor information. In addition, the process may include determining a preventive action to prevent the attack. Further, the process may include sending an indication of the attack to at least one of the robot controller, another robot controller, or another internet of things module. The indication includes the preventive action.

According to certain embodiments, a computer program product encoding instructions for performing a process according to a method including receiving data at an internet of things module in a mobile network from a robot controller. The data includes sensor information from a plurality of machine type communication devices. The method may also include detecting an attack on the mobile network based on the sensor information. In addition, the method may include determining a preventive action to prevent the attack. Further, the method may include sending an indication of the attack to at least one of the robot controller, another robot controller, or another internet of things module. The indication includes the preventive action.

### BRIEF DESCRIPTION OF THE DRAWINGS

For proper understanding of the invention, reference should be made to the accompanying drawings, wherein:

FIG. 1 illustrates a method flow diagram according to certain embodiments.

FIG. 2 illustrates a signal flow diagram according to certain embodiments.

FIG. 3 illustrates a signal flow diagram according to certain embodiments.

FIG. 4 illustrates a table according to certain embodiments.

FIG. 5 illustrates a data classifying and data mining flow diagram according to certain embodiments.

FIG. 6 illustrates a system according to certain embodiments.

FIG. 7 illustrate a signal flow diagram according to certain embodiments.

FIG. 8 illustrates a flow diagram according to certain embodiments.

FIG. 9 illustrates a system according to certain embodiments.

FIG. 10 illustrates a signal flow diagram according to certain embodiments.

FIG. 11 illustrates a system according to certain embodiments.

FIG. 12 illustrates a flow diagram according to certain embodiments.

FIG. 13 illustrates a flow diagram according to certain embodiments.

FIG. 14 illustrates a system according to certain embodiments.

### DETAILED DESCRIPTION

Telecommunication vendors and other industries, including manufacturing, medical, and agriculture, have become increasingly interested in MCR. Because MCR exhibits beneficial operational characteristics, such as resource sharing and a centralized controller, MCR can be used to lower costs and network resource demands. In certain embodiments, data mining and knowledge reuse may be used by the MCR to increase the efficiency and security of the mobile network and/or MTC devices. Certain embodiments may also be used to help perform data analysis to detect potential attacks or problems. For example, if a drone breaks down while delivering vaccines, certain embodiments may be able to take a preventive action to guide other drones to replace it, as well as to recover the failed drone so that it is not stolen. This allows for a secure platform that manages and guides the MCR devices.

In addition, certain embodiments can be used to identify improvements for the MCR environment. For example, some improvements may include processing time, data accuracy, energy saving for different MCR applications, monitoring, security, and/or fault management.

Certain embodiments may perform data mining on data collected from MTC devices, such as sensors or robots, and diagnose the faults or attacks either before, or shortly after, they occur. The received data from the MTC devices may be mined and classified by a network entity. This collected data may then be made available to other service providers, other mobile networks, or other robot controllers in order to prevent a similar attack from occurring on any other entity in the network, or in nearby networks. In certain embodiments, a mobile network cloud platform may be used to collect the data from the MTC devices, perform data mining and classification, and analyze the data at the mobile network to detect attacks.

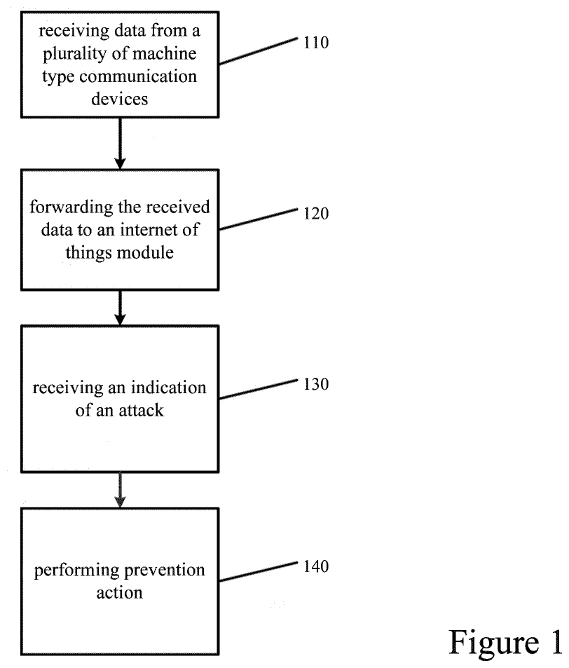

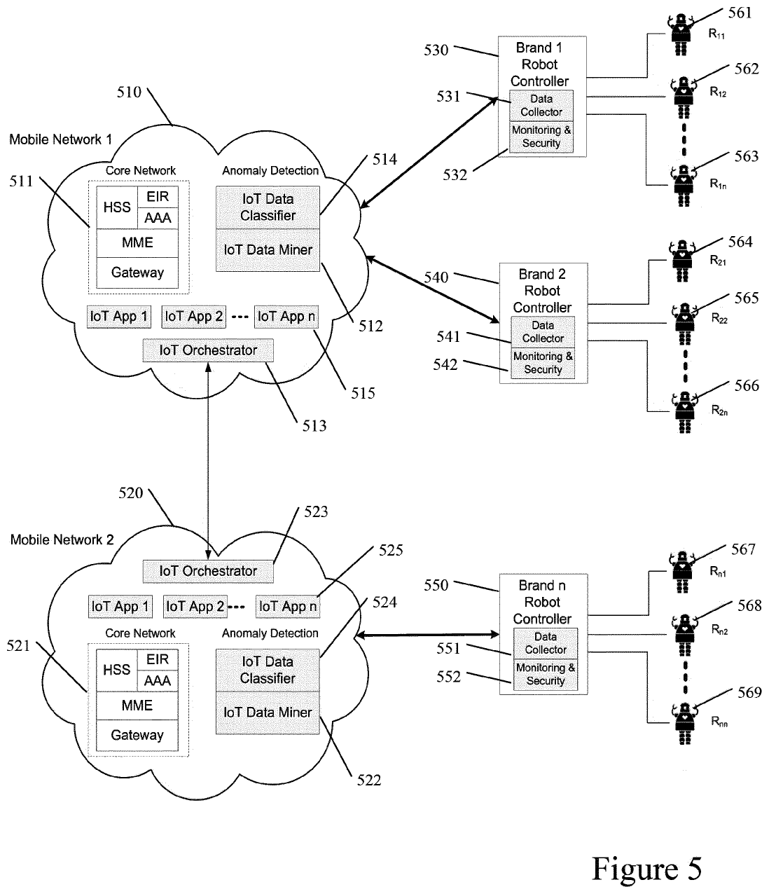

FIG. 1 illustrates a flow diagram according to certain embodiments. In particular, FIG. 1 illustrates an embodiment from the perspective of a robot controller, as shown in FIG. 5. In step 110, the robot controller may receive data from a plurality of MTC devices. The data may have been collected by the MTC devices using at least one sensor in a given industrial environment. The data, which includes the sensor information from the plurality of the MTC devices, is then sent from the MTC devices to the robot controller. Sensor information may be any data received, detected, and/or collected by an MTC device using hardware. For example the data may be user plane and/or control plane data which may include an attack. The robot controller may in certain embodiments be labeled a local robot controller that may directly interact with the MTC devices in a given industrial area and/or act as a gateway to the mobile network. In other words, the robot controller may be local because it may communicate with the mobile device without requiring communication through the mobile network.

In some embodiments the robot controller may be located in the base station, while in other embodiments the robot controller may be a mobile edge computing entity. Whether or not the robot controller may be located in the base station, or whether the robot controller may be its own separate entity, may depend on the data collected or received at the robot controller. For example, if the robot controller is receiving data from an MTC device with a military application, the robot controller may not be placed in the base station for privacy and/or security reasons. If the robot controller is receiving data from an MTC device with an agricultural application, on the hand, privacy concerns may be minimized, which may allow the robot controller to be safely located in the base station.

The robot controller may connect to the MTC devices and receive data from the MTC devices during the performance of various functions. For example, local privacy, security and monitoring, local hardware control, local software management, and/or any other applications operating on the MTC device may transmit data to the robot controller. Although certain embodiments described below may focus on security and monitoring, the robot controller may receive data related to any of the above functions from the MTC devices. The security functions may involve at least authentication, authorization, accounting, integrity, and/or availability of data. To ensure that such security functions are properly enforced, the MTC devices may send data related to such security functions, including sensor information, to the robot controller.

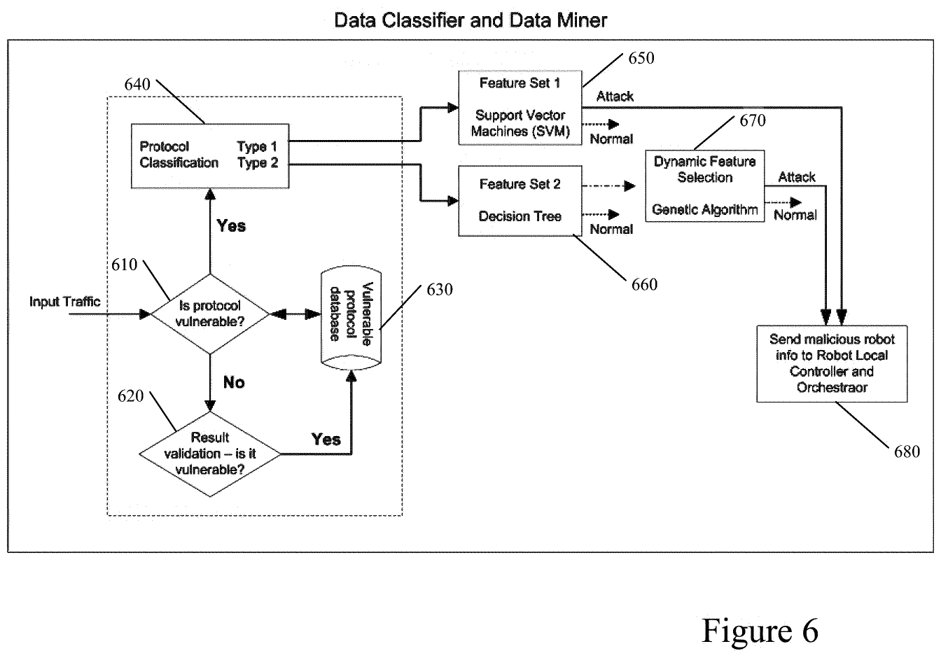

Once the robot controller receives the data from the plurality of MTC devices, the robot controller may forward the data to a network entity, such as an internet of things module, as shown in step 120. An internet of things module may be an internet of things device, an internet of things apparatus, a cloud based device, and/or an internet of things cluster that may include an internet of things data classifier, an internet of things data miner, and/or internet of things orchestrator. The internet of things module may include a processor, memory, transceiver, or any other hardware later described. The data from the MTC device may therefore be sent to the network via a robot controller and/or via a base station. The internet of things module, shown in more detail in FIG. 6, may be an anomaly detection entity or a mobile network cloud platform that performs data mining and classification on the received data. The received data is mined and classified by the internet of things module to determine whether the network and/or any of the plurality of the MTC devices is facing a possible attack.

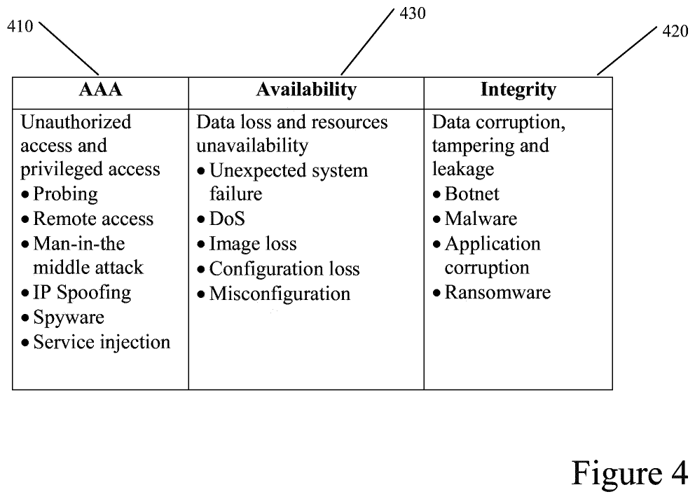

An attack may be any kind of malicious behavior which may cause at least one network service to degrade, or even cause at least one network service to become unavailable. An attack may also be theft of network information, or an unauthorized or unwelcomed intrusion into the mobile network. For example, attacks may include denial-of-service (DOS) attack on a mobility management entity (MME) through a burst of signaling messages, configuration corruption, and/or stealing information from the home subscriber server (HSS). In certain embodiments, an attack may be an attack on the robot or the drone itself, which may not include stealing network information. Rather, an attack on the robot or drone itself may result in theft of information from the robot or drone, and can misguide the robot or drone. In addition, attack in any form can also target the local robot controller. FIG. 4 includes a further list of possible attacks according to certain embodiments.

The data received from the robot controller may be made available to at least one other mobile network and/or at least one other robot controller. Because the internet of things module may receive data from a plurality of robot controllers, an internet of things module may perform collective data mining and classification of all of the data forwarded to the network from the plurality of robot controllers. As will be discussed below, certain embodiments may include a combination of one learning and one linear algorithm. Once the data is mined and classified, the internet of things module, which may be a mobile network cloud platform, may analyze the received or collected data to detect any attack. The attack may be detected by the internet of things module based on an anomaly in the received or collected MTC device data. An indication of the attack may be sent or distributed to the robot controller from which the data was received, to at least one another robot controller, and/or to at least one other mobile network. As can be seen in step 130, for example, the robot controller may receive an indication of the attack.

The indication may not only be used to inform robot controllers or other mobile networks of the attack, the indication may also include information directed to a prevention action. The prevention action may be determined by the internet of things module based on the determined attack and/or the data received from the robot controller. For example, a prevention action may be a mitigation strategy for either preventing the attack or decreasing the harmful effects of the attack. In some other embodiments, the prevention action may include a recovery strategy for fixing or negating the impact of the attack. In step 140, the robot controller may use the indication received from the internet of things module to perform the prevention action, and either prevent or limit the detected attack. Performing of the prevention action may include forwarding instructions to the MTC device for how to deal with the attack.

The internet of things module may be associated with at least one service provider. The service provider, for example, may be either a mobile network operator or a mobile virtual network operator (MVNO). When an attack has been identified in the mobile network, a notification may be sent to all MVNOs by the internet of things module. For example, an internet of things orchestrator may be used to send the indication to counterparts in other MVNOs. Notifying other MVNOs or other mobile networks of the attack may be used to prevent an attack on the cloud platform from the other MVNOs, who without the notification may not be aware of the malicious nature and/or intent of a robot. Certain embodiments may therefore reduce the resources dedicated to the computation of an attack, because an attack detected by a single mobile network or MVNO may be used to inform the other network operators or mobile networks.

In certain embodiments, collecting or receiving data from at least one MTC device, as shown in step 110 of FIG. 1, may include the use of different application layer or transport layer protocols. For example, hypertext transfer protocol (HTTP), user datagram protocol (UDP), transmission control protocol (TCP), and/or simple service discovery protocol (SSDP) may be used. In other embodiments, any other type of protocol may be used. The protocol used may be specific to the vendor of the MTC device or may be based on the MTC device application. The vendor, for example, may be the manufacturer or the operator of the MTC device. The vendor may determine the type of data and the type of protocol used by the MTC device. Some embodiments, for example, may be based on proprietary protocols of the vendors. The proprietary protocol may be based on the vendor's specifications, which are made available by the vendor itself.

The data received by the robot controller may be categorized or classified into at least two groups, including control plane data and user plane data. Control plane data, for example, may include signaling data such as non-access stratum (NAS), or any other data related to authentication or security, bearer request, paging, and/or location area updates. User plane data, on the other hand, may cover telemetry and command-control data. Telemetry data, for example, may be related to application of the MTC devices and their geographic locations. For example, images, video, measurements, such temperature or speed, and/or HTTP traffic.

In certain embodiments, data may also be classified as command-control data. Command-control data may be related to control data of the MTC device. For example, the command-control data may include status check, software update, and/or task management data. Some or all of the user plane data may be normalized before being processed for anomaly detection. Normalization of data may include at least partial standardization of data in order to allow for the mining and/or the classification of the data by the internet of things module. For example, all of the received data may have three layers in common, while the remaining layers may be determined by the vendors. This may allow for all of the data, regardless of the brand or the application, to be processed for anomaly detection by the internet of things module. Detection of an anomaly in data may indicate an attack.

In certain embodiments, data is received by a robot controller and then forwarded to the internet of things module. A service provider, such as an MVNO, may operate an internet of things module that received the data from the robot controller via a base station. Using the internet of things module, the MVNO may share the normalized data with at least one other MVNO. However, in some embodiments, at least one MVNO may deny access to their network for vendors that do not open their data specifications to the operator, and export only normalized data using commonly agreed upon data models. Commonly agreed upon data models may include three common layers between data reported from all vendors. By denying access to their specification, and not exporting normalized data, vendors prevent the internet of things module from properly mining and classifying the received data. Therefore, those vendors that do not normalize data using an agreed upon data model may not be granted access to the network. In some cases it may be possible to reverse engineer a vendor specification, in order to determine the correct data protocol to be used.

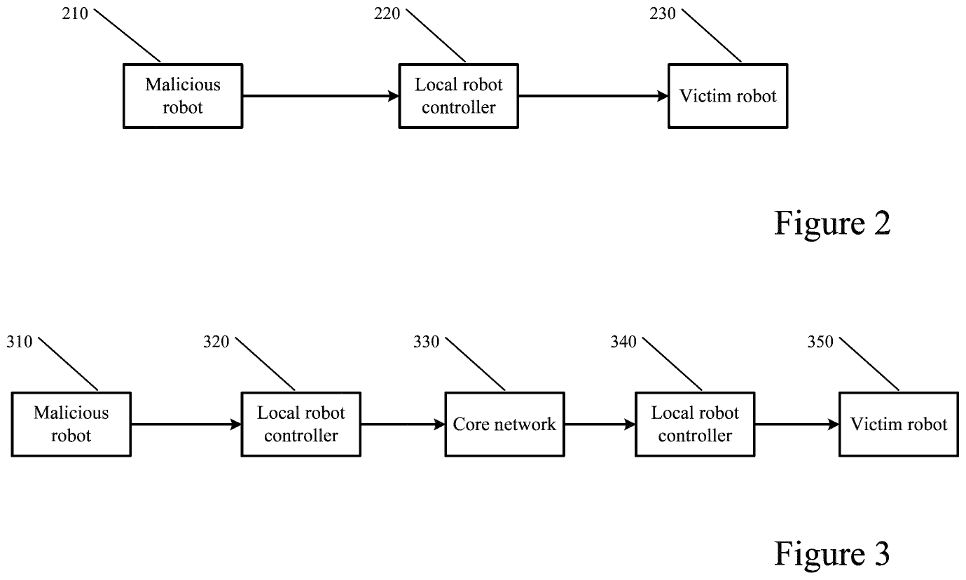

In the event of an attack, the mobile network itself and/or the MTC device may be the intended target. An attack may be any kind of malicious behavior which may cause the degradation of at least one network service, or even cause at least one network service to become unavailable. FIG. 2 illustrates a flow diagram according to certain embodiment. In particular, FIG. 2 illustrates an attack from an MTC device against another MTC device belonging to the same brand. Belonging to the same brand may mean that the operator and/or manufacturer of the MTC device and the victimized MTC device are the same. For example, if both MTC devices were drones, then both drones may be used for the same application, such as a military application. As can be seen in FIG. 2, a malicious MTC device 210, such as a malicious robot, may attempt to attack a victim MTC device 230, such as a victim robot, through a local robot controller 220. The robot controller may be specific to the application of the MTC devices and/or the type of data it receives from the MTC device.

FIG. 3 illustrates a flow diagram according to certain embodiments. In particular, FIG. 3 illustrates an attack from an MTC device against another MTC device belonging to a different brand. Belonging to a different brand may mean that a different MVNO is used to operate both of the attacking MTC device and the victimized MTC device. As shown in FIG. 3, malicious MTC 310, such as malicious robot, may use local robot controller 320 to reach core network 330. Malicious MTC 310 may then go through core network 330 to reach local robot controller 340, and ultimately reach victim robot 350, which may belong to a different brand. An attack on one MTC device against another MTC device may include, for example, corruption and tampering of the another robot's data and/or mission, stealing another robot's data, and/or overloading or flooding the another robots with consecutive requests.

As discussed above, an attack on a mobile network or MTC device may include any kind of malicious behavior, which causes the degradation of network services, renders network services unavailable, or steals network information. For example, a denial-of-service attack on a MME may include a burst of signaling messages, configuration corruption, and/or stealing HSS information.

FIG. 4 illustrates a table of attacks according to certain embodiments. In particular, FIG. 4 illustrates a table of classes of attacks based on security requirements. The three classes shown in FIG. 4 are authentication, authorization, and accounting (AAA) threats 410, availability threats 420, and integrity threats 430. Any other class of threats may also be provided for. AAA threats 410 may include unauthorized access and privileged access, which may involve an attacker gaining access to a system without proper authorization. For example, AAA threats 410 may include probing. Probing may be an attempt to monitor a robot and/or steal information, such as open ports and internet protocol (IP) addresses of robots connected to network. Another AAA threat 410 may be or include remote access. A remote access threat may involve an attempt to access the robot without having permission to do so.

The remote access may be made possible by exploiting a vulnerability. Other AAA threats 410 may include user to root access, in which the attacker starts off as a user and uses his user privileges to gain root access to the system, and/or man-in-the middle attack. A man-in-the-middle attack may occur when an attacker gains access to the communication channel established between a machine type communication device and a local robot controller or between two machine type communication devices. The attacker in a man-in-the-middle attack may be capable of performing unauthorized activities, such as intercepting robot data and/or modifying communications to change the robot mission. Other attacks may include internet protocol (IP) spoofing. IP spoofing may include an attacker that creates IP packets with a false source IP address in order to hide its own identity, and introduces itself as another robot to steal data.

In some other embodiments, AAA threat 410 may include phishing, and/or spyware, in which software may be used to monitor and steal robot information. Another AAA threat 410 may include a service injection attack, in which an attacker targets a robot service and injects malicious code to corrupt the service.

Availability threats 420 may include data loss and resources unavailability. In other words, the attack may lead to unexpected failure in which machine type communication devices and local robot control firmware and/or configuration may be lost or corrupted, which may make the robot unavailable. For example, availability threats 420 may include data removal, unexpected system failure, abusive use, denial-of-service (DOS), image loss, configuration loss, and/or misconfiguration. As part of a DOS availability threat, an attacker may occupy the network resources by flooding network with consecutive requests and/or cause denial of services to robots.

Integrity threats 430 may involve data corruption, tampering, and/or leakage threats. In other words, the attacker aims to distort the data or code used by the application. For example, integrity threats 430 may include botnet, malware, application corruption, and/or ransomware, which may block access to a computer system until a sum of money is paid. Botnet, for example, may be a group of connected vulnerable machine type communication device in a network, which are remotely controlled by a master computer, also known as a hacker. Similar to a machine type communication device, the hacker may automatically perform some functions that are predefined by the botmaster, and forward the information like viruses to target local robot controller or machine type communication devices, which could cause denial of service. Botmaster may be a master computer that operates the various commands and/or controls of the botnets behaving maliciously.

Malware, for example, may include various software codes, such as viruses, worms, and/or Trojans. Malware attacks are programmed to perform malicious operations on a machine type communication. Ransomware, on the other hand, may be any kind of software that locks a robot, and demands some form of payment to unlock the robot.

FIG. 5 illustrates a system according to certain embodiments. As shown in FIG. 5, certain embodiments may include a three layered system including MTC devices, robot controllers, and an internet of things module in the mobile networks. MTC devices 561-569, such as robots, may be connected to mobile networks 510, 520 via robot controllers 530, 540, and 550. In certain embodiments, security and/or authentication may utilize a subscriber identity module (SIM) card or an embedded universal integrated circuit card (eUICC) located in the MTC devices or the robot controller. In other embodiments, security and/or authentication may be performed without a SIM card or a eUICC.

Robot controllers 530, 540, and 550 may be central nodes for MTC devices in a given area. Each robot controller may, in certain embodiments, be responsible for controlling hardware, software, and/or security policy for all MTC devices in a given area. For example, controlling hardware may mean controlling a power of an MTC device, while controlling software may include controlling drivers, and other applications that run on the drivers.

As can be seen in FIG. 5, each robot controller 530, 540, and 550, may have at least a monitoring and a security end. Monitoring and security ends 532, 542, and 552 may be used to monitor key performance indicators (KPI) related to the hardware and/or software of the MTC devices. Monitoring and security ends 532, 542, and 552, may receive or collect data from the MTC devices and send the data to data collectors 531, 541, and 551, respectively. The data collector and the monitoring and security ends may be housed without the same robot controller, while in other embodiments they may be housed in different controllers. The robot controller, specifically the data controller therein, may act as a gateway for a given industrial environment or area, and may collect the data from the MTC devices in the given area. The data controller may in certain embodiments continuously communicate with the mobile network, and send data to the internet of things module, as shown in step of 120, for data mining and classification of the data at the mobile network. The data may be sent to the mobile network via a base station.

In certain embodiments, there may be no direct communication between MTC devices, such as robots. For example, MTC devices 561, 562, and 563 may not directly communication with one another. If the MTC devices belong to the same brand, the local robot controller may take care of trust management, and facilitate communication between the MTC devices. On the other hand, if the MTC devices belong to different brands, the mobile network, rather than the robot controller, may take care of trust management. In doing so, the mobile network may help to correlate information between the at least two different robot controllers.

As shown in FIG. 5, the MTC devices communicate with the robot controller, located outside the mobile network, which then sends information to the internet of things module in the mobile network side 510, 520. The internet of things module may be a cloud based device, and may perform anomaly detection on the data it receives from robot controllers 530, 540, and 550. The internet of things module, for example, may be an anomaly detection entity. If no anomaly is detected, the internet of things module may forward the received data to core network 511, 521. Although FIG. 5 illustrates that the mobile network includes several internet of things entities, some or all of the entities may all be included in a single internet of things module. For example, the internet of things data classifier 514, 524 and internet of things data miner 512, 522 may be included in a single internet of things module.

In certain embodiments, an internet of things data miner 512, 522 may be used. The data received from the robot controller may be heterogeneous in nature, meaning that the data can be received from different internet of things modules, having different traffic profiles and using different resources. The received or collected data, therefore, may be mined, meaning that the data may be combined, processed, correlated, labeled, and/or categorized. The internet of things data miner may perform this mining, and may label data in an efficient manner so that it may easily be classified by the internet of things data classifier 514, 524. In some embodiments, the internet of things data miner may also perform data normalization, meaning that the data received from the MTC devices may be standardized to allow for analysis of the data.

In certain embodiments, the internet of things module may also include an internet of things data classifier 514, 524. The classifier, for example, may utilize a J48 decision tree algorithm to group and label the received data. The classification of the received data may vary depending on the purpose of the attack or anomaly detection. J48 decision tree algorithm may be an optimized version of the decision tree algorithm. The decision tree may be either an open source algorithm or a user specific algorithm based on the optimization. The optimization, which may be a factor in algorithm performance, may depend on tuning of the algorithm and/or on the data type. Optimization may also depend at least in part on a robot data type and/or the protocol specification of a vendor.

FIG. 6 illustrates a flow diagram according to certain embodiments. In particular, FIG. 6 illustrates anomaly detection, also known as attack detection, by the internet of things data miner 512, 522, and internet of things data classifier 514, 524. In other words, detecting an attack by the internet of things module may include detecting anomalies in the data received from the MTC devices, through the at least one robot controller. The detected anomalies may indicate at least one type of attack. The sensor information or data may therefore be analyzed twice. First, local robot controller monitors and analyzes data via detection, such as firewalls, intrusion detection system, and/or policy control. Second, MVNO analyzes the received data via an internet of things anomaly detection module.

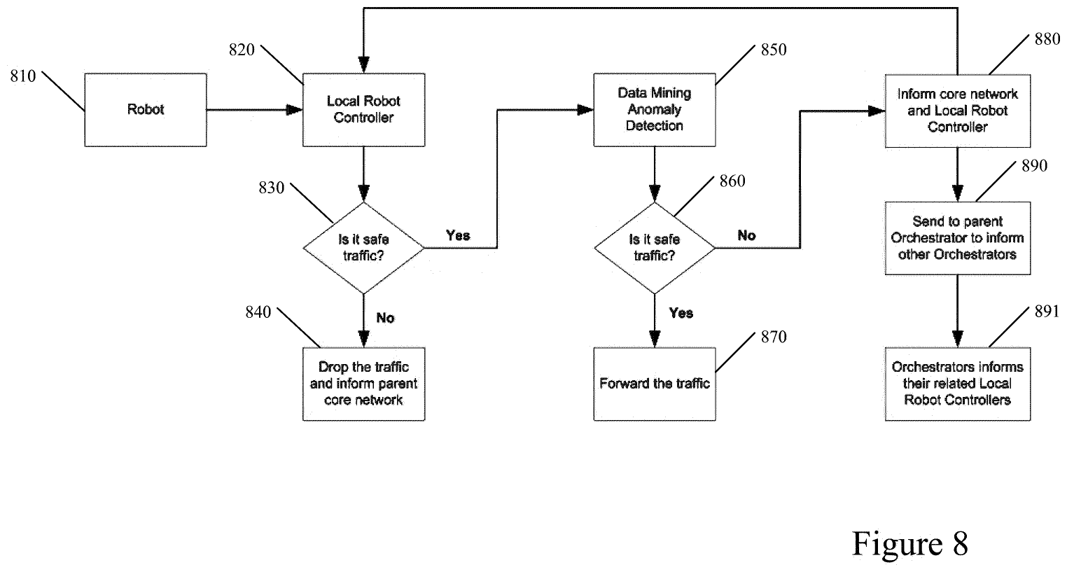

An embodiments of the analysis of the sensor information or data is shown in FIG. 8. When a MTC device tries to connect to a MVNO, first MTC device is authenticated internally by the robot controller. Based on the policies or rules which are locally defined in the robot controller, the traffic would be either dropped or passed to MVNO. If the traffic is dropped at the robot controller, a notification message may be sent to MVNO. Later, MVNO may inform other MVNOs about malicious MTC device through the internet of things orchestrator. If the traffic is deemed safe, and traffic reaches MVNO, the internet of things anomaly detection module will check through algorithms whether the traffic is safe or not. If the traffic is not safe, it would be dropped and a notification message may be sent to the associated robot controller and through the associated internet of things orchestrator to other MVNOs. If the traffic is labeled safe in the internet of things anomaly detection module, however, the MVNO may forward the traffic to the core network.

In other embodiments, anomaly detection may be used for detecting traffic safety or any other application in which an anomaly may be detected. The data mining and classifying mechanisms in FIG. 6 may be used to detect all type of anomalies, and also to feed the information for example to a public warning system, as described in 3GPP TS 22.268. 3GPP TS 22.268 is hereby fully incorporated by reference. The public warning system may be used to send a warning in the form of a cell broadcast to alarm any MTC devices in the affected area about the potential attack.

The classes into which the data may be classified are defined based on at least one feature, which is either predefined, extracted based on training data, or dynamically defined during the analysis process. For example, a feature of the data may include the source IP address, the packet size of the data, or the destination IP address. In other words, the features may refer to characteristics of the data itself. Any combination of features may be possible.

As shown in FIG. 6 as whole, traffic can be input into the Internet of Things module, which may include a data classifier and/or a data miner. A determination may be made of whether the protocol of input traffic is vulnerable in view of the data received by the internet of things module based on the vendor, as shown in step 610. Data that is not vulnerable, for example, may be streaming data, such as a video feed. The data may be deemed not vulnerable because attacking of such a data may not be done. For example, the content of a video stream may not be attacked. Vulnerable data, on the other hand, may be any other type of data that may be attacked.

If the protocol is not vulnerable, a second determination may be made of whether the result of the validation, rather than the protocol itself, may be vulnerable, as shown in step 620. If so, the data may be input into the vulnerable protocol data, as shown in step 630, and the protocol vulnerability may then be assessed again, as shown in step 610. In certain embodiments, a Self-Organizing Map (SOM) algorithm may be optimized to determine whether the data is vulnerable or not. If the protocol is vulnerable, then the protocol may be classified in step 640 as a type 1 and/or a type 2 protocol.

Based on the used protocol for carrying the input data, either a type 1 or a type 2 classifier may be used. For the type 1 protocol, the support vector machine which has predefined feature set 1 may be used, as shown in step 650. When the type 1 classification is deemed an attack, the internet of things module, using the internet of things orchestrator, may send an indication to at least one robot controller and/or at least one other mobile network, as shown in step 680. A type 2 classification, on the other hand, may be based on an optimized version of J48 decision tree algorithm, as shown in step 660. When a type 2 classification is deemed a potential attack, then dynamic feature selection occurs in accordance with a dynamic feature selection which is a Fuzzy Genetic Algorithm, as shown in step 670. The classification based on the dynamic feature selection may be deemed as either attack traffic, which is data that indicates an attack, or as safe traffic. In step 680, the internet of things module may then send an indication to at least one robot controller, which may forward the message to at least one MTC device, and/or at least one other mobile network via the internet of things orchestrator. The indication may be sent in the form of an alert, a flag, a message, and/or data. The indication of the attack may be sent to the at least one robot controller and/or to at least one other mobile network in any other form.

FIG. 6 illustrates a combination of different methods to investigate a hybrid model for achieving better attack detection performance. A hybrid model may include a Protocol Analyzer (PA) used to filter input data and to separate normal traffic, which is not deemed to be a threat, from an attack. PA may include a decision module that may check whether or not traffic is carried on any known vulnerable protocol. The PA may also include a counter that includes a list of known pre-defined mobile network vulnerable protocols, such as HTTP and TCP, while other protocols like real time streaming protocol (RTSP) may be a safe protocol. A module may include a processor, memory, transceiver, or any other hardware or software.

The functions of the counter may be based on prioritization and threshold. If the protocol carries an attack for several times, meeting a given threshold, then the current protocol in use may be considered a vulnerable protocol. When the protocol is considered vulnerable, the traffic suspected as an attack may be forwarded to a next layer for detection and labelling. When the protocol carrying the input data is not listed as vulnerable in the counter, traffic may be sent to an SOM algorithm for result validation. The SOM algorithm, which may serve as a data mining algorithm, may check whether the protocol is vulnerable.

For DoS detection, since the DoS attack may mostly come on known protocols, such as TCP and/or UDP, in certain embodiments no unknown patterns may be labeled. SVM algorithm, which may be faster and more accurate, as compared to other linear algorithms, may be used. The use of the SVM algorithm is shown as Feature Set 1 in step 650 of FIG. 6. For first round testing and training the SVM algorithm may be given a set of features which are known for DoS attack, such as packet size and response time. For example, when the packet size or response time is very small it may be an attack. Because the DoS may normally generated by script, rather than by a human, it may have a much shorter response time than human. Other features known for DOS attack may be similarly selected.

For Feature Set 2, shown as step 660 in FIG. 6, since unknown and new pattern may not be recognized, a decision tree, which may be a linear algorithm with a fast classifying feature, may be used. In such an embodiment, the packet may be labeled as an attack or as normal traffic regardless of type of attack. A decision tree algorithm may also include a comparison between attack traffic and normal traffic. In such a decision tree algorithm, the features may be continuously reduced until a set of the most proper features is reached.

Each type of attack may have a specific feature, such as packet size, response time, source and destination IP address, and/or port. At first place, based on the known attacks a group of features may be selected for any of the algorithms described above or below. For example, for an attack called shell code in which the packet size and response time are too small, the most proper features may be the response time and the packet size. Therefore, at first time we train the algorithm with a list of known features. After each time the algorithm is run, and based on the algorithm structure, an error report may be sent back to the algorithm that shows the different between the actual output and the expected output. In other words, the algorithm may change the features in order to get less of an error factor. In certain embodiments, therefore, in the first place, an algorithm labels the data to one of the attacks which has closest features similarity to predefined features. If there is no similarity between the input packet features and predefined features, the input packet's new features will be added to the algorithm so that the algorithm may be tuned with the most proper features.

Examples of the most proper features may be at least Ethernet size, Ethernet destination, Ethernet source, Ethernet protocol, IP header length, IP type of service, IP length, IP time to live, IP protocol, IP source, IP destination, TCP source port, TCP destination port, UDP source port, UDP destination port, UDP length, internet control message protocol (ICMP) type, ICMP code, source IP, destination IP, duration of connection, connection starting time, connection ending time, number of packets sent from source to destination, number of packets sent from source to destination, number of packets sent from Destination to Source, number of data bytes sent from Source to Destination, number of data bytes sent from Destination to Source, number of Fragmented packets, number of Overlapping Fragments, number of Acknowledgement packets, number of Retransmitted packets, number of Pushed packets, number of synchronization (SYN) packets, number of finish (FIN) packets, number of TCP header Flags, and/or number of Urgent packets.

In certain other embodiments, the most proper features may include, number of unique connections used by the same source IP (SrcIP) as the current record, which may calculated connections in the last D interval (Time Based features) divided by the last k connections (Connection Based features). In some other embodiments, the most proper feature may be the number of unique connections used by the same SrcIP on the same destination port (Dst-Port) as the current record, which may be calculated based on the last D interval divided by the last k connections. In other embodiments, the most proper feature may be as follows: number of unique connections used by the same SrcIP on different Dst-Port as the current record, which may be the last D interval divided by the last k connections, the number of unique connections used by the same SrcIP as the current record that have SYN flag, the number of unique connections used by the same SrcIP as the current record that have RST flag, the number of unique connections that use the same destination IP (DstIP) as the current record, the number of unique connections that use the same DstIP on the same Dst-Port as the current record, the number of unique connections that use the same DstIP on different Dst-Port as the current record, the number of unique connections that use the same DstIP as the current record that have SYN flag, the number of unique connections that use the same DstIP as the current record that have RST flag, the number of unique ports used by the same SrcIP to connect on the same DstIP and the same Dst-Port as the current record, the number of unique ports opened on the same DstIP by the same SrcIP as the current record, the number of unique connections that use the same service as the current packet, the number of unique connections that use the same service and have different DstIP as the current packet, the number of unique connections that use the same service as the current packet that have SYN flag, and/or the number of unique connections that use the same service as the current packet that have RST flag.

Certain embodiments may include dynamic feature selection. In dynamic feature selection, a genetic algorithm (GA) may be used. A GA may provide for an excellent tool to label new types of attack with accuracy as compared to other learning algorithms. In a GA, one or more known features are defined based on knowledge about botnet attack (B) and/or malicious codes (M), such as viruses and worms. Based on a given GA structure, an error report may be consistently sent back to the GA, which may show how different the actual output may be from the expected result or output.

The GA may dynamically change the structure of the algorithm and the features associated with the GA in order to obtain a lesser error factor. For example, the GA may label the data to one of the attacks which has the closest features or similarity, and if the error factor is higher than a threshold it may consider the packet as new type of attack. A dynamically changing GA may be said to be a learning algorithm. The hybrid detection model may be used to detect attacks on MTC devices. When the hybrid detection model determines that the data is safe, the internet of things module may then forward the data to core network 510, 520, as shown in FIG. 5.

The internet of things module, as shown in FIG. 5, may also include at least one internet of things application 515, 525. The mobile network may include up to n number or applications. The applications may provide an interface between the application layer of the internet of things module and the various internet of things uses. For example, the applications may be an interface for smart parking, smart home automation, security, or any other application.

FIG. 5 also illustrates an internet of things orchestrator 513, 523 that is located within the mobile network 520, 510. The internet of things orchestrator may distribute an indication of an attack to nearby mobile networks using, for example, an orchestration component. The indication may also include a prevention action. Once the indication is received by the at least one internet of things module in the other mobile network, the at least one other mobile network may perform a prevention action. A prevention action may include sending information from the internet of things module to a robot data collector to identify and mitigate an attack, such as a malicious robot. A robot data collector may trace back the malicious robot and block it from authentication to the MCR.

In some embodiments, a prevention action may also be known as a mitigation strategy, which can safely be applied if the malicious robot is attempting to be authenticated within either the same cloud service provider, such as MVNO, or any other cloud service provider. The internet of things orchestrator may therefore be used to distribute an indication that includes information about the attack, such as malicious pattern and information on the malicious robot to all MVNOs so that they may take preventative action, retaliate against the attack, and/or mitigate the effects of the attack. In some embodiments, each mobile network may include one or more internet of things orchestrator that may communicate with one another. In other embodiments, the orchestrator may be used for any intra or inter network communication. The internet of things orchestrator may be located within the internet of things module or as its own separate entity outside the internet of things module.

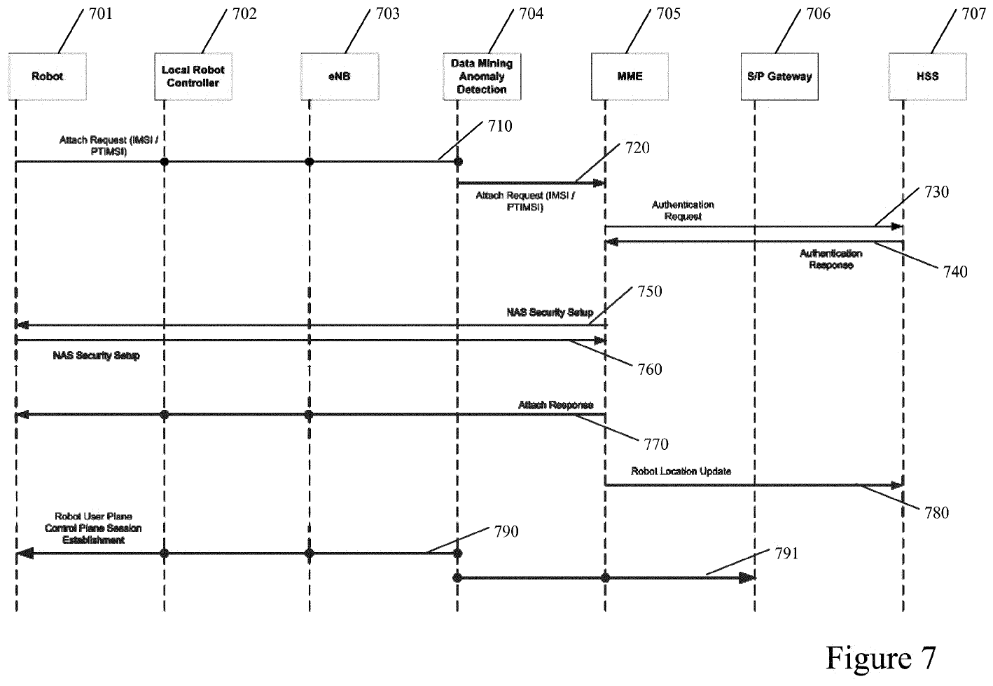

FIG. 7 illustrates a signal flow diagram according to certain embodiments. In particular, FIG. 7 illustrates authentication and session establishment of a MTC device, for example a robot, to a mobile network. In step 710, robot 701 sends an attachment request, which may include an international mobile subscriber identity (IMSI) and/or a packet temporary mobile subscriber identity (P-TMSI). The request may be sent through robot controller 702 and/or base station 703, for example an enhanced NodeB (eNB), to internet of things module 704, for example a data mining anomaly detection entity, in the mobile network. The base station, therefore, may connect the robot controller and/or the internet of things module in the mobile network. In some embodiments, the robot controller may be the base station, while in other embodiments the robot controller may be its own separate entity, such as a mobile edge computing platform.

Data mining anomaly detection 704 may then forward the attach request to MME 705, as shown in step 720. In step 730, the MME may forward the authentication request to HSS 707. In step 740, HSS 707 may send MME 705 an authentication response message. MME 705 may then initiate a NAS security setup with the robot 701, in step 750, and in step 760 robot 701 may perform the NAS security setup by sending a response back to MME 705. In step 770, MME 705 may send an attach response message to robot 701. The MME may, in step 780, send HSS 707 a robot location update. Data mining anomaly detection entity 704 may then send a robot user plane control plane session establishment message to robot 701, as shown in step 790. Internet of things module 704, also known as data mining anomaly detection entity, may also send a message to the serving or packet data network (S/P) gateway 706, informing the gateway of the establishment of the user plane control session with robot 701.

FIG. 8 illustrates a flow diagram according to certain embodiments. In particular, FIG. 8 illustrates an anomaly detection and mitigation procedure in a mobile network. MTC device 810, for example, a robot, may send a message to robot controller 820. The robot controller may then make a determination on whether the traffic is safe, as shown in step 830. For example, a MTC device vendor may choose their preferred monitoring and security mechanisms such as firewalls, intrusion detection system (IDS), or any other type of security monitoring and/or security mechanism. If the traffic is not safe, the traffic may be dropped, as shown in step 840, and the robot controller may inform the core network. In certain embodiments, when traffic is malicious, a notification including some features related to the malicious robot may be forwarded to the core network. For example, the HSS or AAA within the core network may be responsible for drone authentication, and as such may be provided with the notification. In addition, other MVNOs may be provided with a notification via orchestrators. This can allow the same malicious robot to be dropped without the traffic of the malicious robot being analyzed at a future point in time. If the traffic is safe, however, data mining anomaly detection may occur, as shown in step 850, within the network.

The data mining anomaly detection entity may then determine whether the traffic is safe, as shown in step 860. If the traffic is safe, the data may be forwarded to the core network, as shown in step 870. On the other hand, if the traffic is unsafe, then the local robot controller may be informed, as shown in step 880. In step 890, the internet of things orchestrator, as shown in FIG. 5 as entity 513, may inform other internet of things orchestrators or other mobile networks that the received data is unsafe. In step 891, the one or more internet of things orchestrators may also inform at least one robot controller.

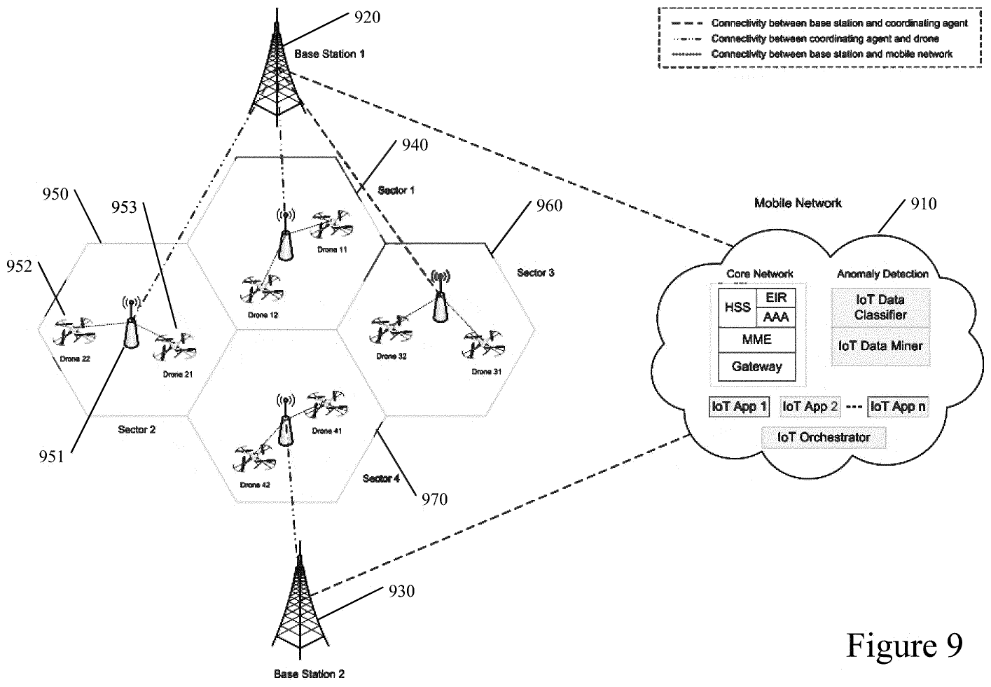

FIG. 9 illustrates a system diagram according to certain embodiments. In particular, FIG. 9 illustrates the internet of things security architecture for MTC devices, such as drones. As can be seen in FIG. 9, the area in which the drones operate may be divided into n number of sectors for coverage and management reasons. As can be seen in FIG. 9, the environment is divided into four different sectors, sector 1 940, sector 2 950, sector 3 960, and sector 4 970. Each sector may have one or more robot controllers that may be fixed at a location, and the robot controllers may be authenticated using the nearest base station of the mobile network operator in the area. In some other embodiments, any other base station may be used to authenticate the robot controller. For example, sector 2 950 may include robot controller 951, a first drone 952, and a second drone 953. Base station 920 may be used to authenticate robot controller 951, while base station 930 may be used to authenticate the robot controller located in sector 4 970.

The robot controller may be the primary contact for the drones operating in the area. Every drone operating in an area may, for example, first be authenticated to the robot controller. After authentication with the robot controller, the drone may be assigned with a task, and the drone may start working towards completion of that task. In addition to task assignment, task cancellation, and/or task replacement processes, the robot controller may also collect parameters of interest related to the drones. For example, the parameters of interest may be location of the drone, task assigned to the drone, route that the drone takes to reach a destination, security parameters, and logs from each of the drones connected to the robot controller. The robot controller may then send the collected information to either base station 920 or base station 930, depending on the location of the robot controller. The base station may then forward the information to mobile network 910 for analysis by the internet of things module. The sending of the information may be periodic.

In certain embodiments, the coverage area of each robot controller may be limited. As an MTC device, such as a drone, moves away from the area of one robot controller, it may be authenticated by another robot controller in the current area of the drone. The process may be similar to providing service to a subscriber that is roaming between mobile networks. In some embodiments, there may be communication between two robot controllers, similar to handover or roaming. When a drone leaves an area covered by a robot controller, and enters an area covered by another robot controller, handover may be initiated and the drone may be authenticated.

As described above, if the internet of things module, including the internet of things classifier and the internet of things miner, detects an anomaly in the data, this may amount to an attack on any MTC device connected to the mobile network. The internet of things module may be detect the attack, and indicate to the robot controller to initiate prevention action, which may include mitigation strategy. The prevention action may start with cancellation of the suspicious task, and the triggering of an automatic clean-up of malware or malicious content.

If automatic clean up activity fails, in certain embodiments, then the internet of things module may receive a signal from the robot controller indicating as much, and may send a message to the service center in the mobile network to perform a manual clean-up, to de-authenticate the malicious MTC device, such as a drone, from the network. In case the suspicious domain does not belong to the mobile network operator, the malicious MTC device may be placed on a blacklist of malicious MTC devices that have been detected as carrying out attacks. An updated blacklist, or individual updates to the blacklist, may be sent to all robot controllers attached to the network, so that the blacklist may be kept consistent among all robot controllers. Once on the blacklist, an MTC device may not be able to authenticate and connect to the mobile network anymore, which may prevent any potential attack that may harm the network services or the cloud platform itself.

In certain embodiments, a robot controller may coordinate the MTC devices, and their movement patterns. For example, a robot controller may subscribe to a service, such as an internet of things application, as shown in FIG. 5, which may allow the mobile operator to notify the robot controller of a detected attack or a detected anomaly. For example, the flight pattern of a drone may be detected based on telemetry received from various robot controllers, and the flight pattern of the drone may be detected as going beyond a predefined flight sector limit to a no-fly zone. In such an embodiment, the network may inform the robot controller closest to the no-fly zone to de-authenticate the drone or to take another prevention action. Coordinate system adaptation may therefore be part of the data normalization process, to allow the internet of things module to analyze flight patterns.

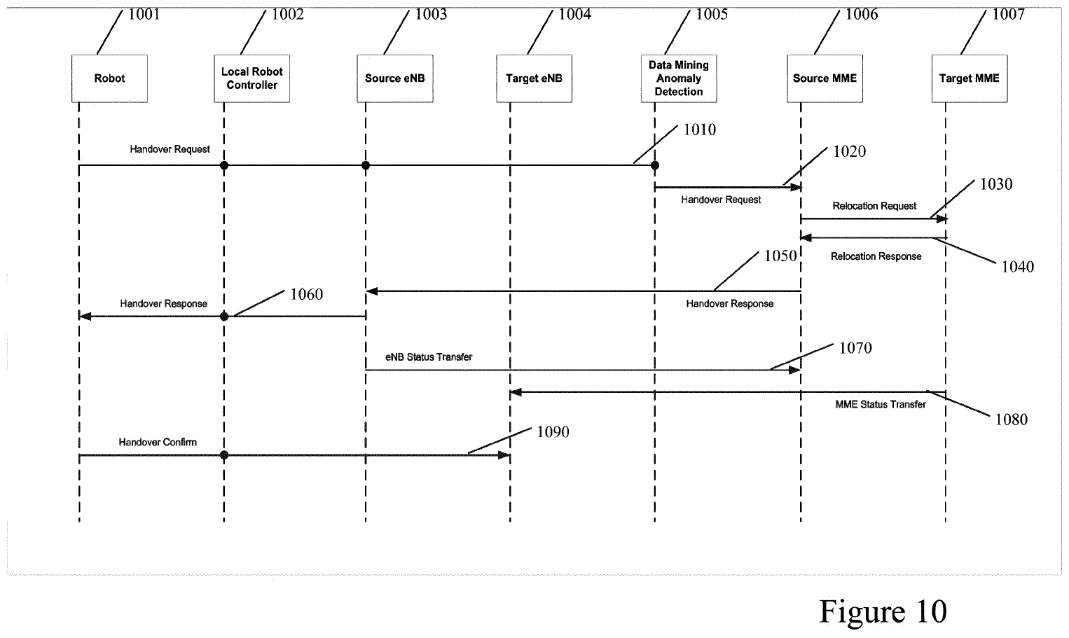

FIG. 10 illustrates a signal flow diagram according to certain embodiments. In particular, FIG. 10 illustrates roaming between cloud service providers MVNO. MTC devices may communicate, in certain embodiments, using intra MVNO communication in which data is received from a fixed or moving MTC device. An MTC device may therefore be fixed at a certain location, and the MTC device may communication with another MTC device inside the MVNO. In other embodiments, MTC devices may communicate via inter MVNO communication. In inter MVNO communication, a fixed MTC device or a moving MTC device, such as a drone, may move to a different MVNO, and tries to communicate with other MTC devices in the original or a different MVNO.

In yet another embodiment, the MTC device may communicate via roaming between MVNOs, as illustrate in FIG. 10. The fixed or moving MTC device may move to a different MVNO, and may try to communicate with other MTC devices. In the embodiments of FIG. 10, the MTC device has been at a certain location, and has then been physically moved to another location. The authentication request may be sent to a nearby robot data collector of the MVNO.

As can be seen in step 1010, MTC device 1001, such as a robot, may send a handover request through robot controller 1002 and source base station 1003, for example an eNB, to a data mining anomaly detection entity 1005. Data mining anomaly detection entity 1005 may then forward the request to source MME 1006, as shown in step 1020. In step 1030, source MME 1006 may send the relocation request to a target MME 1007, and source MME 1006 may receive a relocation response in step 1040. In step 1050, source MME 1006 returns the handover response to source eNB 1003, which may then forward the handover response to MTC device 1001 through robot controller 1002, as shown in step 1060. In step 1070, source eNB 1003 may send an eNB status transfer notification to source MME 1006, which indicated to source MME 1006 that MTC device 1001 is about to be handed over to target eNB 1004. Target MME 1007 may then inform target eNB 1004 of an MME status transfer, as shown in step 1080. In step 1090, a handover confirmation may then be sent to the target eNB 1004 via robot controller 1002.

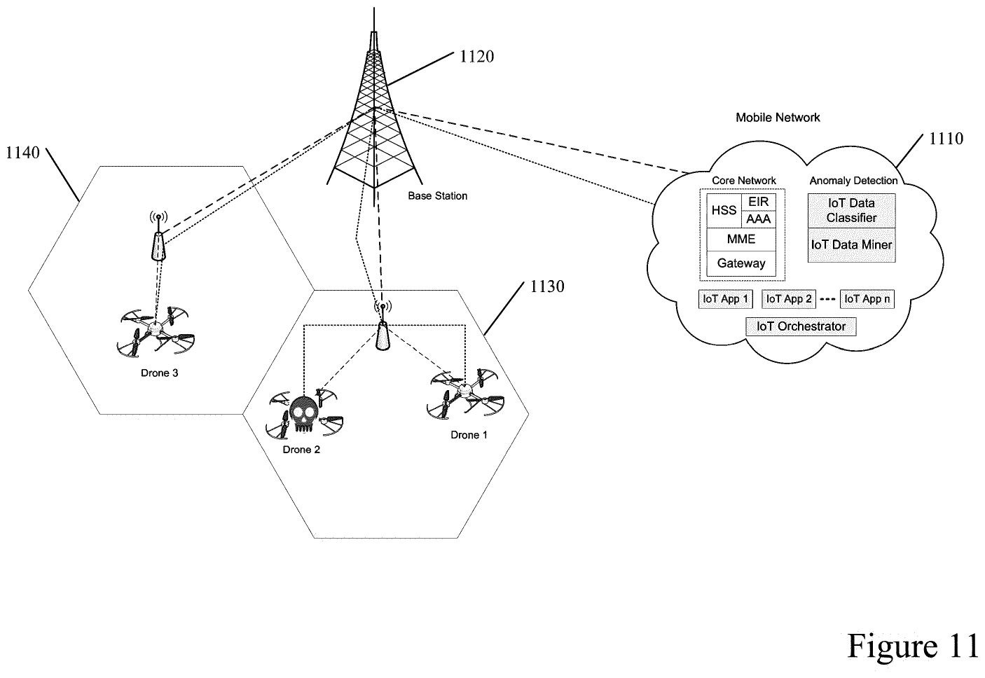

FIG. 11 illustrates a system according to certain embodiments. In particular, FIG. 11 illustrates a MTC device attack scenario, which includes attack detection of the whole MVNO. The environment displayed in FIG. 11 includes two sectors, 1130, 1140. Sector 1140 has a single drone, while sector 1130 has two different drones. Drone 2, located in sector 1130, is an attacker drone, while drones 1 and 3, located in sectors 1130 and 1140, respectively, are victim drones. Drones 1 and 2, located in sector 1130, belong to the same robot controller, and may have the same brand. Drone 3, on the other hand, is located in sector 1140 and belongs to a different sector and/or a different brand.

In certain embodiments, drone 2 may attempt to attack drone 1 directly using a robot controller, while drone 2 may attempt to attack drone 3 indirectly via MVNO. The system, in FIG. 11, includes a base station 1120, which the robot controller may use to communicate with mobile network 1110. As discussed above, the robot controller along with the internet of things module located in the mobile network may be analyzed to detect the attack, and to determine and perform a prevention action.

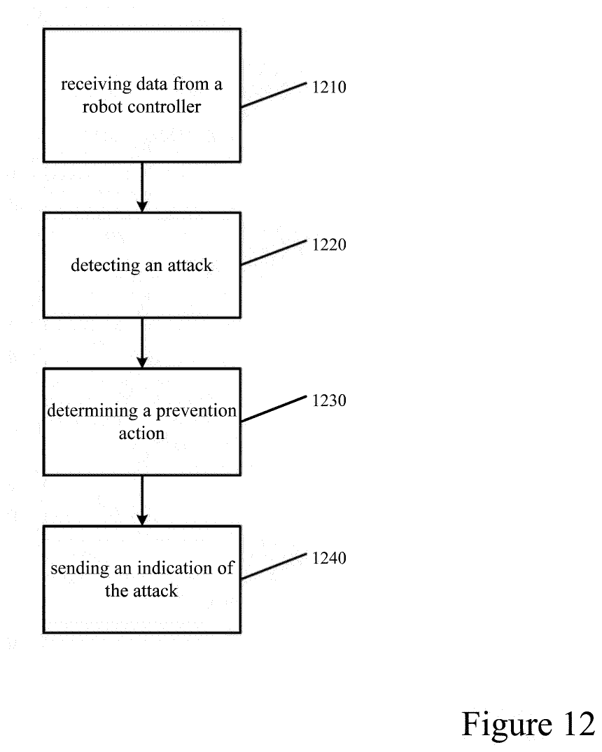

FIG. 12 illustrates a flow diagram according to certain embodiments. In particular, FIG. 12 illustrates an embodiment of the internet of things module. In step 1210, the internet of things module may receive data at an internet of things module in a mobile network from a robot controller. The data may include sensor information from a plurality of MTC devices. In step 1220, the internet of things module, using at least an internet of things data mines and/or internet of things data classifier, may detect an attack on the mobile network based on the sensor information. The internet of things module may then determine a preventive action to prevent the attack on the network, as shown in step 1230. In step 1240, the internet of things module may send an indication of the attack to at least one of the robot controller, another robot controller, or another internet of things module. The indication comprises the preventive action. An internet of things orchestrator may be used to send the preventive action.

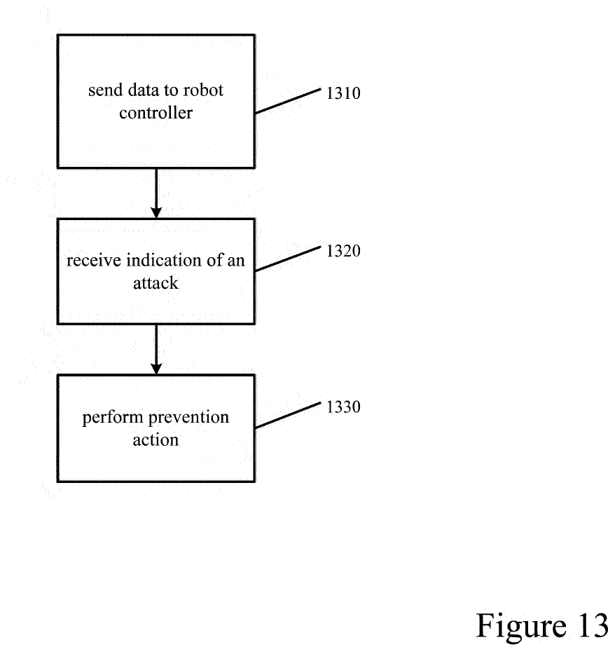

FIG. 13 illustrates a flow diagram according to certain embodiments. In particular, FIG. 13 illustrates an embodiment of the MTC device, for example a robot. In step 1310, the MTC device may send data at a robot controller from a machine type communication device. The data comprises sensor information of the machine type communication device. In step 1320, the MTC device receives at the machine type communication device an indication of an attack via the robot controller from an internet of things device in a mobile network. The indication includes a prevention action. In step 1330, the MTC device may perform the prevention action to prevent the attack.

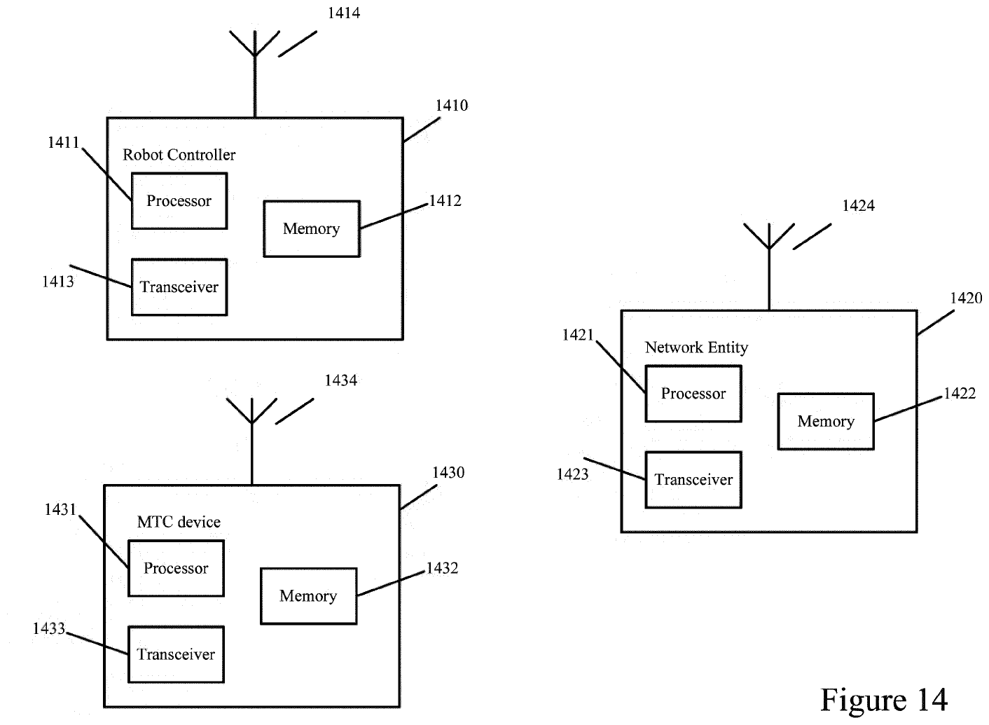

FIG. 14 illustrates a system according to certain embodiments. It should be understood that each signal or block in FIGS. 1-13 may be implemented by various means or their combinations, such as hardware, software, firmware, one or more processors and/or circuitry. In one embodiment, a system may include several devices, such as, for example, robot controller 1410, network entity 1420, and/or MTC device 1430. The system may include more than one robot controllers 1410, more than one network entities 1420, and/or more than one MTC device 1430, although only one of each is shown for the purposes of illustration. The robot controller, for example, may be a server, a host, a mobile computer edge entity, a base station, such as an eNB, or any of the other access node discussed herein. The network entity, on the other hand, may be a server, host, internet of things module that includes an internet of things data classifier and data miner, and/or any other entity within the network that may communicate with the core network.

Each of these devices may include at least one processor or control unit or module, respectively indicated as 1411, 1421, and 1431. At least one memory may be provided in each device, and indicated as 1412, 1422, and 1432, respectively. The memory may include computer program instructions or computer code contained therein. One or more transceiver 1413, 1423, and 1433 may be provided, and each device may also include an antenna, respectively illustrated as 1414, 1424, and 1434. Although only one antenna each is shown, many antennas and multiple antenna elements may be provided to each of the devices. Other configurations of these devices, for example, may be provided. For example, robot controller 1410, network entity 1420, and/or MTC device 1430 may be additionally configured for wired communication, in addition to wireless communication, and in such a case antennas 1414, 1424, and 1434 may illustrate any form of communication hardware, without being limited to merely an antenna.

Transceivers 1413, 1423, and 1433, may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One possible use is to make a network node deliver local content. One or more functionalities may also be implemented as virtual application(s) in software that can run on a server. For example, robot controller 1410 may be a mobile computing edge entity.

A MTC device 1430 user equipment (UE) may be a sensor, monitor, meter, location tag, tracker, security device, robot, robotic device, flying robot, such as a drone, rover, or any other user equipment that may not require any human interaction.

In some embodiments, an apparatus, such as a network entity, a MTC device, and/or robot controller may include means for carrying out embodiments described above in relation to FIGS. 1-13. In certain embodiments, at least one memory including computer program code can be configured to, with the at least one processor, cause the apparatus at least to perform any of the processes described herein.

Processors 1411, 1421, and 1431 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 1412, 1422, and 1432 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network entity 1420, robot controller 1410, or MTC device 1430 to perform any of the processes described above (see, for example, FIGS. 1-13). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

Furthermore, although FIG. 14 illustrates a system including network entity 1420, MTC device 1410, and robot controller 1410, certain embodiments may be applicable to other configurations, and configurations involving additional elements, as illustrated and discussed herein. For example, multiple user equipment devices and multiple network entities may be present, or other nodes providing similar functionality, such as nodes that combine the functionality of a robot controller and a network entity and/or a MTC device and a robot controller. The MTC device 1430 may likewise be provided with a variety of configurations for communication other than robot controller 1410. For example, the MTC device 1430 may be configured for device-to-device, machine-to-machine, robot-to-robot, or drone-to-drone communication.

The above embodiments provide for improvements to the functioning of a network and/or to the functioning of the nodes or computers within the network, or the MTC device communicating with the network. Specifically, certain embodiments allow for a secure data mining platform for MTC devices, such as internet of things robots. For example, data mining and classification may be used to define proper and/or dynamic feature sets, and to detect malicious robots in the MCR. Certain embodiments may also include a preventive action, such as a mitigation strategy, for dealing with an attack from a malicious MTC device. An indication of the attack, as well as the preventive action, may be forwarded to some or all of the nearby cloud service provides. This prevents from each service provider from having to detect an attack that has already been detected by another service provider.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. While some embodiments may be directed to an LTE environment, other embodiments can be directed to other 3GPP technology, such as LTE advanced, 5G, or 4G technology.

### PARTIAL GLOSSARY

3GPP 3rd Generation Partnership Project

IoT internet of things

MTC machine type communication

LTE long term evolution

MCR mobile cloud robots

DOS denial-of-service

MME mobility management entity

HSS home subscriber server

MVNO mobile virtual network operator

HTTP hypertext transfer protocol

UDP user datagram protocol

TCP transmission control protocol

NAS non-access stratum

AAA authentication, authorization, and accounting

SIM subscriber identity module

eUICC embedded universal integrated circuit card

KPI key performance indicators

IMSI international mobile subscriber identity

P-TMSI packet temporary mobile subscriber identity

eNB enhanced NodeB

1. A method comprising:
receiving data at a robot controller from a plurality of machine type communication devices, wherein the data comprises sensor information from the plurality of machine type communication devices;
forwarding the received data to an internet of things module in a mobile network, wherein the sensor information is analyzed to detect an attack on the mobile network;
receiving at the robot controller an indication of the attack from the internet of things module in the mobile network, wherein the indication comprises a prevention action; and
performing the prevention action to prevent the attack.

2. The method according to claim 1, wherein the receiving of the indication at the robot controller from the internet of things module in the mobile network may be received via an internet of things orchestrator.

3. (canceled)

4. (canceled)

5. The method according to claim 1, wherein the received data comprises local security and monitoring data.

6. The method according to claim 1, wherein the prevention action comprises a mitigation strategy, wherein the mitigation strategy comprises cancellation of a task, triggering clean-up of malware or malicious content.

7. The method according to claim 1, wherein the robot controller is at least one of a base station or a mobile edge computing entity.

8. A method comprising:
receiving data at an internet of things module in a mobile network from a robot controller, wherein the data comprises sensor information from a plurality of machine type communication devices;
detecting an attack on the mobile network based on the sensor information;
determining a preventive action to prevent the attack; and
sending an indication of the attack to at least one of the robot controller, another robot controller, or another internet of things module, wherein the indication comprises the preventive action.

9. The method according to claim 8, wherein the indication is sent via an internet of things orchestrator.

10. The method according to claim 8, wherein the internet of things orchestrator or an internet of things application is used to send the indication to the another internet of things module.

11. The method according to claim 8, further comprising:
mining the received data from the robot controller at the mobile network, wherein an internet of things module at least labels or classifies the received data.

12. The method according to claim 11, further comprising:
determining an anomaly at the internet of things module, wherein the anomaly comprises the indication of the attack.

13. The method according to claim 8, wherein the another internet of things module is located in another mobile network, wherein the another mobile network is operated by a separate service provider.

14. The method according to claims 13, wherein the service provider comprises a mobile network operator or a mobile virtual network operator.

15. The method according to claim 8, wherein the detecting of the attack comprises detection of the attack before the mobile network is infected.

16. (canceled)

17. The method according to claim 8, further comprising:
sharing the received data with another mobile network or service provider.

18. The method according to claim 8, wherein the attack comprises at least one of unauthorized access, data loss and resource availability, or data integrity.

19. (canceled)

20. The method according to claim 8, wherein the prevention action comprises preventing authentication of malicious machine type communication device performing the attack.

21. (canceled)

22. An apparatus comprising:
at least one processor; and
at least one memory including computer program code,
wherein the at least one memory and the computer program code are configured to, with the at least one processor, cause the apparatus at least to:
receive data at a robot controller from a plurality of machine type communication devices, wherein the data comprises sensor information from the plurality of machine type communication devices;
forward the received data to an internet of things module in a mobile network, wherein the sensor information is analyzed to detect an attack on the mobile network;
receive at the robot controller an indication of the attack from the internet of things module in the mobile network, wherein the indication comprises a prevention action; and
perform the prevention action to prevent the attack.

23. An apparatus comprising:
at least one processor; and
at least one memory including computer program code,
wherein the at least one memory and the computer program code are configured to, with the at least one processor, cause the apparatus at least to:
receive data at an internet of things module in a mobile network from a robot controller, wherein the data comprises sensor information from a plurality of machine type communication devices;
detect an attack on the mobile network based on the sensor information;
determine a preventive action to prevent the attack; and
send an indication of the attack to at least one of the robot controller, another robot controller, or another internet of things module, wherein the indication comprises the preventive action.

24.-27. (canceled)

28. A computer program product embodied in a non-transitory computer-readable medium and encoding instructions that, when executed in hardware, perform a process, the process according to claim 1.

29. A computer program product embodied in a non-transitory computer-readable medium and encoding instructions that, when executed in hardware, perform the process according to claim 8.
